(19) United States
(12) Patent Application Publication
(10) Pub. No.: US 2012/0049732 A1
(43) Pub. Date: Mar. 1, 2012

(54) LED LIGHT BULB

(76) Inventor: Sheng-Yi CHUANG, Hsinchu City (TW)

(21) Appl. No.: 12/869,276

(22) Filed: Aug. 26, 2010

(51) Int. Cl. H01K 1/62

(52) U.S. Cl. 315/32

(57) ABSTRACT

An LED light bulb includes a heat conductive post coupled with a plurality of LED circuit boards. The LED circuit boards are electrically connected to a first current converged board and a second current converged board. The first and second current converged boards also are connected respectively to a first conductive wire and a second conductive wire to converge current of the LED circuit boards. The heat conductive post further is connected to a heat sink which has a wiring aperture threaded through by the first and second conductive wires and a coupling portion coupled with a lampshade. The invention also includes an electric connection structure coupled with the heat sink in an insulation manner. The electric connection structure is electrically connected to the first and second conductive wires and connected to a power source to supply electric power through the first and second conductive wires.

### FIELD OF THE INVENTION

The present invention relates to an LED (light emitting diode) light bulb and particularly to an LED light bulb equipped with an exposed heat sink and a circuit board to converge current to prevent the heat sink from receiving the current.

### BACKGROUND OF THE INVENTION

LED provides many advantages such as longer lifespan, less electric power consumption, greater brightness and utilizing eco-friendly materials. With advance of LED fabrication processes and cost reduction, applications of LED become increasingly popular, asides from used on traffic lights or indication lights on electric appliances, they also are adopted on lighting fixtures for environment decoration and illumination. To make the LEDs to be applied to the ordinary light bulbs, a technique has been developed to couple the LEDs with a casing of the conventional light bulb.

For instance, R.O.C. patent No. M358247 entitled “LED lamp adaptable to varying sockets” discloses “an LED lamp adaptable to varying sockets includes a cooling module with juxtaposed radiation fins and a universal fast latch end adaptable to various sockets to form quick coupling of the sockets with varying specifications and the cooling module” in its abstract. Its structure includes an LED cooling module (1) with an opening (12) at a coupling end and an annular latch groove (13) surrounding the opening (12) to couple with a corresponding socket (2). The opening has one end coupled with an LED lighting element (3) electrically connected to the socket (2). The LED cooling module (1) is located on the periphery of the LED lighting element (3) and socket (2) to disperse heat. While the LED cooling module can disperse heat, the LED lighting element is surrounded by the LED cooling module and the light emitted by the LED lighting element is confined only in the front direction.

R.O.C. patent No. 1312850 entitled “LED lamp set equipped with a heat sink structure” discloses “an LED lamp set equipped with a heat sink structure includes a socket, a heat sink coupled with the socket and a plurality of LED modules connected to the heat sink to conduct heat. The LED modules are attached to the periphery of the heat sink. The heat sink includes a hollow barrel. The socket has a plurality of air vents to form an airflow passage with the barrel” in its abstract. Its structure includes a socket, a heat sink coupled with the socket and a plurality of LED modules connected to the heat sink to conduct heat. The LED modules are attached to the periphery of the heat sink. The heat sink includes a hollow barrel. The socket has a plurality of air vents to form an airflow passage with the barrel. With the LEDs are surrounded on the periphery of the heat sink, light projecting range of the LEDs increases and heat of the LEDs is directly conducted to the heat sink. But it does not mention whether a glass lampshade is installed. To conform to the general perception of light bulb and safety when in use (to avoid electric shock or touching the heat sink incidentally), most products are encased by a glass lampshade. If the glass lampshade is used directly to encase the LEDs and heat sink, heat of the heat sink can only be dispersed by airflow flowing through the air vents. In the event that the flowing speed of the airflow is not fast enough or air temperature is higher, waste heat will still be accumulated continuously on the heat sink. Moreover, flowing of the airflow inside the glass lampshade is difficult, the LEDs and glass lampshade could be overheated after used for a long time.

In short, there are still rooms for improvement on the conventional LED lamp sets in terms of cooling capability and illumination efficacy.

### SUMMARY OF THE INVENTION

In view of the problems of the conventional LED light bulbs that have to be encased in a lampshade to meet users' perception but result in undesirable air ventilation and overheated concern, the primary object of the present invention is to provide an LED light bulb with improved cooling capability and a heat sink structure capable of effectively conducting heat outside the light bulb without accumulating waste heat in the lampshade on LED circuit boards.

The LED light bulb according to the invention includes a heat conductive post connected to a plurality of LED circuit boards which surround the heat conductive post. The heat conductive post has a through hole. Each of the LED circuit boards has a first electrode end and a second electrode end. A first current converged board is provided to electrically connect to the first electrode end and also connect to a first conductive wire to converge current of the LED circuit boards. A second current converged board is provided to electrically connect to the second electrode end and also connect to a second conductive wire to converge the current of the LED circuit boards. The heat conductive post is connected to a bearing surface of a heat sink which has wiring aperture threaded through by the first and second conductive wires and a coupling portion to couple with a lampshade to encase the heat conductive post. The invention also includes an electric connection structure to couple with the heat sink in an insulation fashion. The electric connection structure is electrically connected to the first and second conductive wires through the wiring aperture, and also is connected to a power source to supply electric power through the first and second conductive wires to drive the LED circuit boards.

The structure thus formed can conduct heat of the LED circuit boards to the heat conductive post which further conducts the heat to the heat sink. The heat sink is exposed outside the lampshade and has a greater cooling area in contact with air, hence can quickly conduct the heat from the interior of the lampshade outside. Moreover, with the current of the LED circuit boards is converged on the first and second current converged boards and is connected with the electric connection structure through the first and second conductive wires, the current does not pass through the heat conductive post and heat sink, therefore the heat sink can be exposed outside the lampshade in contact with the air directly, an improved cooling effect can be accomplished.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the LED light bulb of the invention.

FIG. 2 is another exploded view of the LED light bulb of the invention.

FIG. 3 is a sectional view of the LED light bulb of the invention.

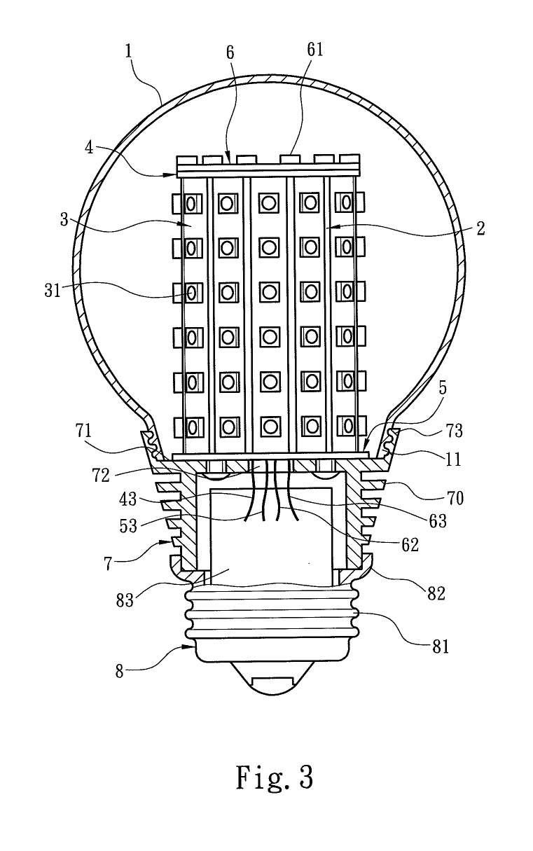

### DETAILED DESCRIPTION OF THE PREFERRED EMBODIMENT

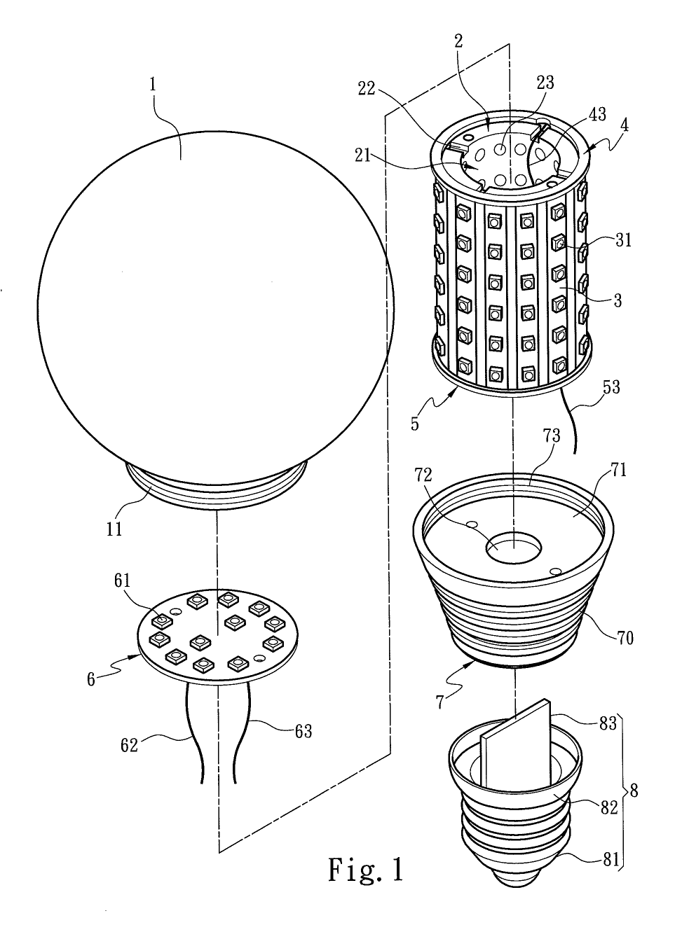

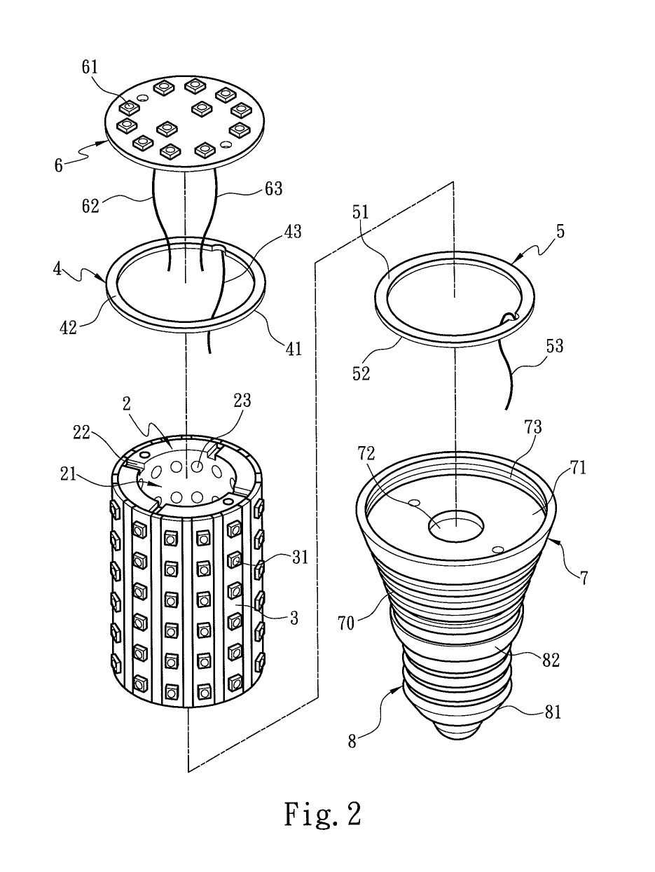

The present invention aims to provide an LED light bulb. Referring to FIGS. 1 and 2, the LED light bulb includes a heat conductive post 2 coupled with a plurality of LED circuit boards 3. The heat conductive post 2 is a hollow post and has a through hole 21 inside with an inner wall formed with a plurality of cavities 23 to increase air contact area. The LED circuit boards 3 are connected with each other and surround the periphery of the heat conducive post 2. Each LED circuit board 3 has a plurality of LEDs 31 coupled in series. With the LED circuit boards 3 surrounding the periphery of the heat conductive post 2, light generated by the LEDs 31 can project in multiple directions for surrounding illumination effect. The LED circuit board 3 has a first electrode end and a second electrode end formed at an upper and a lower end thereof connected respectively to a high voltage end and a low voltage end of a DC power to conduct the DC power to drive the LEDs 31 to emit light. To conduct the electric power to the LED circuit boards 3, the LED light bulb of the invention further includes a first current converged board 4 and a second current converged board 5 that have respectively a conductive surface 41 and 51 and an insulation surface 42 and 52 on another side opposing to the first and second conductive surfaces 41 and 51. The first conductive surfaces 41 and 51 are electrically connected to the LED circuit boards 3 with the first voltage ends of the LED circuit boards 3 electrically connected to the first current converged board 4 and the second voltage ends electrically connected to the second current converged board 5. The electrical connection among the LED circuit boards 3, first current converged board 4 and second current converged board 5 can be soldered or other techniques known in the art. Hence the current flows in and out of the LED circuit boards 3 through the first current converged board 4 and second current converged board 5. The conductive surface 41 of the first current converged board 4 further is connected to a first conductive wire 43 and the conductive surface 51 of the second current converged board 5 is connected to a second conductive wire 53 that converge the current of the LED circuit boards 3. The first current converged board 4 is located at one end of the heat conductive post 2 with the first conductive wire 43 threading through the through hole 21 directed to another end of the heat conductive post 2. The heat conductive post 2 also has a plurality of wiring notches 22 to facilitate wiring of the first or second conductive wires 43 or 53. Besides the heat conductive post 2 is coupled with the LED circuit boards 3, first current converged board 4 and second current converged board 5, the heat conductive post 2 also has one end coupled with a heat sink 7. The heat sink 7 has a bearing surface 71 to connect the heat conductive post 2 through screws or other fastening means known in the art, such as by screwing through internal and external threads formed respectively on the surfaces of the heat sink 7 and heat conductive post 2. The heat sink 7 has wiring aperture 72 threaded through by the first and second conductive wires 43 and 53, and a coupling portion 73 to couple with a lampshade 1. The lampshade 1 has a connection end 11 coupled with the coupling portion 73. The lampshade 1 also encases the heat conductive post 2. The LED light bulb of the invention thus formed has a profile like the conventional light bulb to conform to general users' perception. The invention also includes an electric connection structure 8 which is coupled with the heat sink 7 in an insulation manner but electrically connected to the first and second conductive wires 43 and 53 through the wiring aperture 72, and also is connected to a power source to supply electric power through the first and second conductive wires 43 and 53 to drive the LED circuit boards 3. Through the aforesaid structure, current is conducted from the electric connection structure 8 and flows through the first conductive wire 43, first current converged board 4, LED circuit boards 3, second current converged board 5 and second conductive wire 53 and finally returns to the electric connection structure 8 to form a current loop. Through the conductive surfaces 41 and 51 and the insulation surfaces 42 and 52, current does not flow through the heat conductive post 2 and heat sink 7. Thus the heat sink 7 can be exposed outside the lampshade 1 to prevent the users from electric shock. The heat sink 7 has a cooling surface on the periphery exposed to the air, and a plurality of radiation fins 70 formed on the cooling surface to enhance cooling capability. The electric connection structure 8 includes a metal conductive holder 81 connected to the power source, a power conversion circuit 83 electrically connected to the metal conductive holder 81 to output DC power, and an insulation casing 82 coupled and interposed between the metal conductive holder 81 and heat sink 7. The power source can be a general socket indoors. The metal conductive holder 81 is coupled with the socket to receive electric power, and can be formed in varying profiles according to existing socket specifications. The insulation casing 82 and heat sink 7 can be coupled by screwing through internal threads and external threads formed on the surfaces thereof. The first and second conductive wires 43 and 53 are electrically connected to the power conversion circuit 83 which outputs the DC power through the first and second conductive wires 43 and 53, and then the current flows through the LED circuit boards 3 to ignite the LEDs 31 to generate light. The heat conductive post 2 has one end connected to the bearing surface 71 of the heat sink 7 and another end connected to a circuit board 6 with a plurality of LEDs 61 at an opening of the through hole 21. The circuit board 6 contains a third conductive wire 62 and a fourth conductive wire 63 running through the through hole 21 and wiring aperture 72. The third and fourth conductive wires 62 and 63 are connected to the power conversion circuit 83 to receive the DC power. Thus, the LEDs 61 and 31 located respectively on the circuit board 6 and LED circuit boards 3 can provide multiple directions for illumination, and the light can be projected to the front side and around the heat conductive post 2. The circuit board 6 can be directly fastened to the heat conductive post 2 through screws in a contact manner to conduct heat to the heat conductive post 2.

By means of the construction set forth above, the present invention provides many benefits over the conventional LED light bulbs, notably: 1. the LEDs 31 and 61 are encased in the lampshade 1 to generate similar illumination effect to a conventional light bulb; 2. the first current converged board 4 and second current converged board 5 converge current to prevent the current from passing through the heat conductive post 2 and heat sink 7, so that the heat sink 7 can be exposed outside in the air to avoid the users from electric shock; 3. the heat sink 7 is exposed in the air, and heat from the LED circuit boards 3 and circuit board 6 can be conducted from the heat conductive post 2 to the heat sink 7 to be dispersed to the air, so that heat inside the lampshade 1 can be conducted to the heat sink 7 to protect the LEDs 31 and 61 from being damaged by overheating.

While the invention has been described by means of specific embodiment, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. An LED light bulb, comprising:
a heat conductive post including a through hole and being coupled with a plurality of LED circuit boards on the periphery thereof, and each of the LED circuit boards including a first electrode end and a second electrode end;
a first current converged board electrically connected to the first electrode ends of the LED circuit boards and a first conductive wire to converge current of the LED circuit boards;
a second current converged board electrically connected to the second electrode ends of the LED circuit boards and a second conductive wire to converge the current of the LED circuit boards;
a heat sink which includes a bearing surface connected to the heat conductive post, a wiring aperture threaded through by the first and second conductive wires and a coupling portion connected to a lampshade to encase the heat conductive post; and
an electric connection structure which is coupled with the heat sink in an insulation manner and electrically connected to the first and second conductive wires through the wiring aperture and connected to a power source to supply electric power through the first and second conductive wires to drive the LED circuit boards.

2. The LED light bulb of claim 1, wherein the electric connection structure includes a metal conductive holder connected to the power source, a power conversion circuit electrically connected to the metal conductive holder to output a DC power and an insulation casing coupled with and interposed between the metal conductive holder and the heat sink.

3. The LED light bulb of claim 2, wherein the power conversion circuit outputs the DC power to the first and second conductive wires electrically connected therewith.

4. The LED light bulb of claim 1, wherein the through hole has an opening coupled with a circuit board including a plurality of LEDs, the circuit board including a third conductive wire and a fourth conductive wire threading through the through hole and the wiring aperture, the third and fourth conductive wires being connected to the electric connection structure to conduct the DC power.

5. The LED light bulb of claim 1, wherein the through hole of the heat conductive post includes an inner wall which includes a plurality of cavities to increase contact area with the air.

6. The LED light bulb of claim 1, wherein the heat sink includes a cooling surface on the outer periphery exposed to the air.

7. The LED light bulb of claim 1, wherein the first and the second current converged boards include respectively a conductive surface electrically connected to the first electrode end and the second electrode end and an insulation surface.

8. The LED light bulb of claim 7, wherein the first conductive wire is connected to the conductive surface of the first current converged board and the second conductive wire is connected to the conductive surface of the second current converged board.
